(19) United States
(12) Patent Application Publication
(10) Pub. No.: US 2024/0284447 A1
(43) Pub. Date: Aug. 22, 2024

(54) UPLINK CONTROL INFORMATION ENHANCEMENT FOR LOW-LATENCY AND POWER SAVING

(71) Applicant: QUALCOMM Incorporated, San Diego, CA (US)

(72) Inventors: Wei YANG, San Diego, CA (US); Jae Ho RYU, San Diego, CA (US); Hari SANKAR, San Diego, CA (US); Peter GAAL, San Diego, CA (US); Wooseok NAM, San Diego, CA (US); Tao LUO, San Diego, CA (US)

(21) Appl. No.: 18/441,727

(22) Filed: Feb. 14, 2024

Related U.S. Application Data
(60) Provisional application No. 63/485,861, filed on Feb. 17, 2023.

(51) Int. Cl. H04W 72/1268; H04B 7/06; H04L 1/1812; H04W 72/11; H04W 72/21; H04W 76/20

(52) U.S. Cl. CPC H04W 72/1268; H04B 7/0626; H04L 1/1812; H04W 72/11; H04W 72/21; H04W 76/20

(57) ABSTRACT

Certain aspects of the present disclosure provide a method of wireless communication by a user equipment (UE), comprising obtaining radio resource control (RRC) signaling configuring the UE with at least one physical uplink control channel (PUCCH) resource, obtaining additional signaling indicating an update to the PUCCH resource, and outputting, for transmission, uplink control information (UCI) using the updated PUCCH resource and the new beam.

### CROSS-REFERENCE TO RELATED APPLICATION

This application claims benefit of and priority to U.S. Provisional Application No. 63/485,861, filed Feb. 17, 2023, which is assigned to the assignee hereof and hereby expressly incorporated by reference in its entirety as if fully set forth below and for all applicable purposes.

### BACKGROUND

### Field of the Disclosure

Aspects of the present disclosure relate to wireless communications, and more particularly, to techniques for enhancing uplink control information (UCI) transmissions.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes obtaining radio resource control (RRC) signaling configuring the UE with at least one physical uplink control channel (PUCCH) resource; obtaining additional signaling indicating an update to the PUCCH resource; and outputting, for transmission, uplink control information (UCI) using the updated PUCCH resource.

Another aspect provides a method for wireless communications at a network entity. The method includes outputting, for transmission, RRC signaling configuring a UE with at least one PUCCH resource; outputting, for transmission, additional signaling indicating an update to the PUCCH resource; and obtaining UCI using the updated PUCCH resource.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 shows an exemplary transmission resource mapping, according to

aspects of the present disclosure.

FIG. 6 depicts an example timeline of physical downlink control channel (PDCCH) monitoring occasions (MOs).

FIG. 7 depicts an example timeline for physical downlink control channel (PDCCH) skipping.

FIG. 8 depicts an example timeline for search space set group (SSSG) switching.

FIG. 9 depicts an example of uplink control information (UCI) transmission and beam alignment.

FIG. 10 depicts an example physical uplink control channel (PUCCH) configuration.

FIG. 11 is a call-flow diagram illustrating an example of enhanced UCI transmission, in accordance with certain aspects of the present disclosure.

FIG. 12 depicts an example of enhanced UCI transmission, in accordance with certain aspects of the present disclosure.

FIG. 13 depicts an example of enhanced UCI transmission, in accordance with certain aspects of the present disclosure.

FIG. 14 depicts a method for wireless communications.

FIG. 15 depicts a method for wireless communications.

FIG. 16 depicts aspects of an example communications device.

### DETAILED DESCRIPTION

Aspects of the present disclosure provide apparatuses, methods, processing systems, and computer-readable mediums for enhanced UCI transmission.

There are various approaches to saving power in wireless networks and corresponding devices. For example, one power saving mechanism for user equipments (UEs) involves limiting the amount of time they spend decoding downlink signals. One example of how to limit decoding is to configure a UE to skip monitoring and decoding of physical downlink control channels (PDCCHs) in certain PDCCH monitoring occasions (MOs). The PDCCH is responsible for carrying downlink control information (DCI). Another example power saving mechanism for a UE to switch from one search space set group (SSSG) that has a higher frequency of PDCCH MOs to another SSSG that has a lower frequency of PDCCH MOs. In some cases, a power saving mode may be dynamically indicated to the UE, for example, via a DCI (e.g., a DCI scheduling an uplink or downlink transmission).

One potential cost to power savings according to these power saving mechanisms is that a UE does not communicate (in either the uplink or downlink direction) when it is not monitoring for PDCCH, which results in latency. In some cases, such power saving mechanisms may be overridden by the UE via an uplink transmission, such as a scheduling request (SR), for example, if the UE has urgent data to transmit. The UE may switch back to regular PDCCH monitoring (e.g., to monitor for an uplink grant) after sending the SR.

A network entity (e.g., a gNB) may only be able to monitor SRs from multiple UEs at the same time if they are sent using a same beam (in a same direction). Thus, the network entity may align SR transmission from different UEs based on their corresponding beam direction. Unfortunately, in some cases, a UE may have changed location or orientation (e.g., due to mobility or handset rotation) before sending the SR to override the power savings mechanism. While the network may issue a beam switch command to address this issue, the beam switch may bring the UE out of alignment with other UEs scheduled with PUCCH resources in the same time period (e.g., same symbol) to transmit SR at the same time. As a result, there may be a delay in the UE being able to send the SR, offsetting some of the latency reduction intended by overriding the power saving mode.

Aspects of the present disclosure may help address this issue, however, by coordinating PUCCH resource updates with a beam switch. Utilizing the mechanisms described herein, PUCCH (e.g., SR) resources may be updated at the same pace as beam updates. As a result, a UE may be able to exit a power saving mechanism sooner, reducing latency and improving overall system performance.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

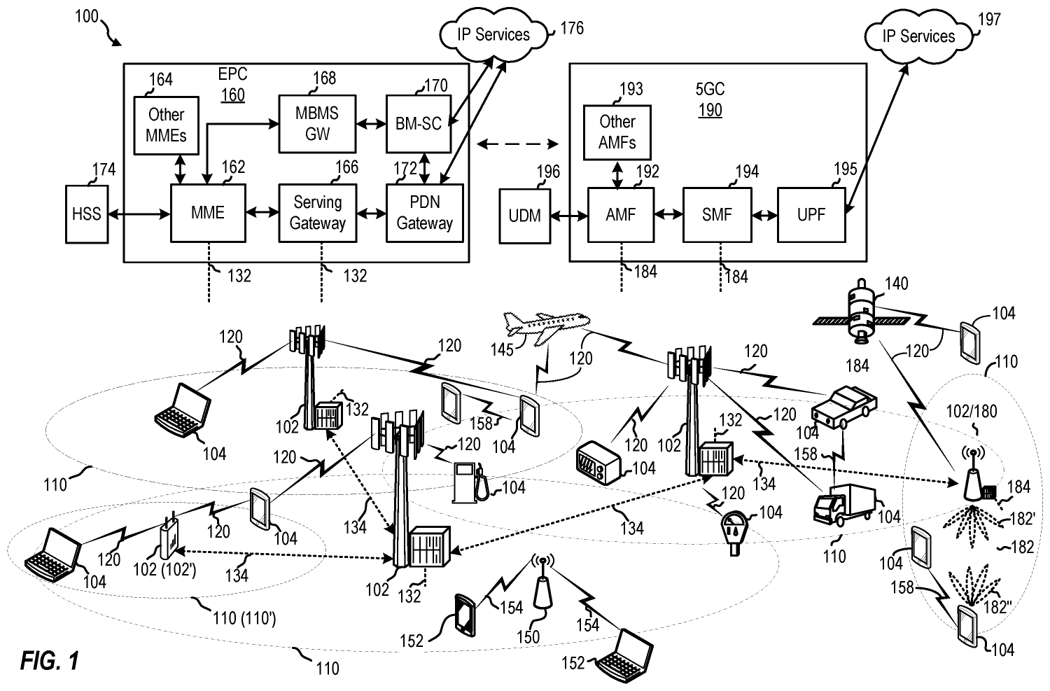

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (CNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

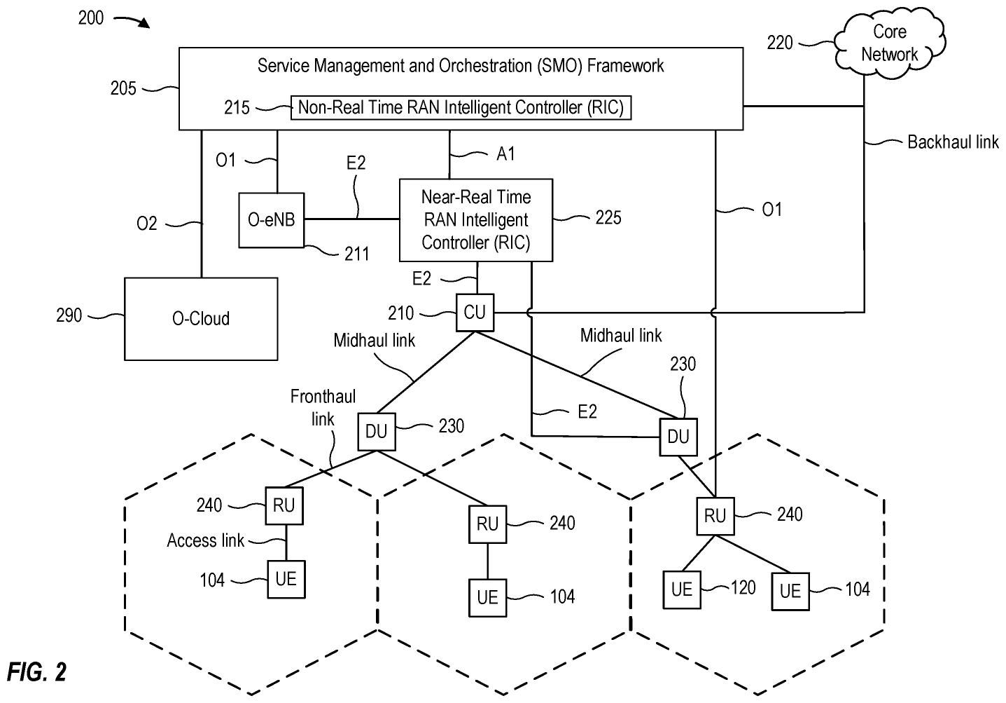

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network clement life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

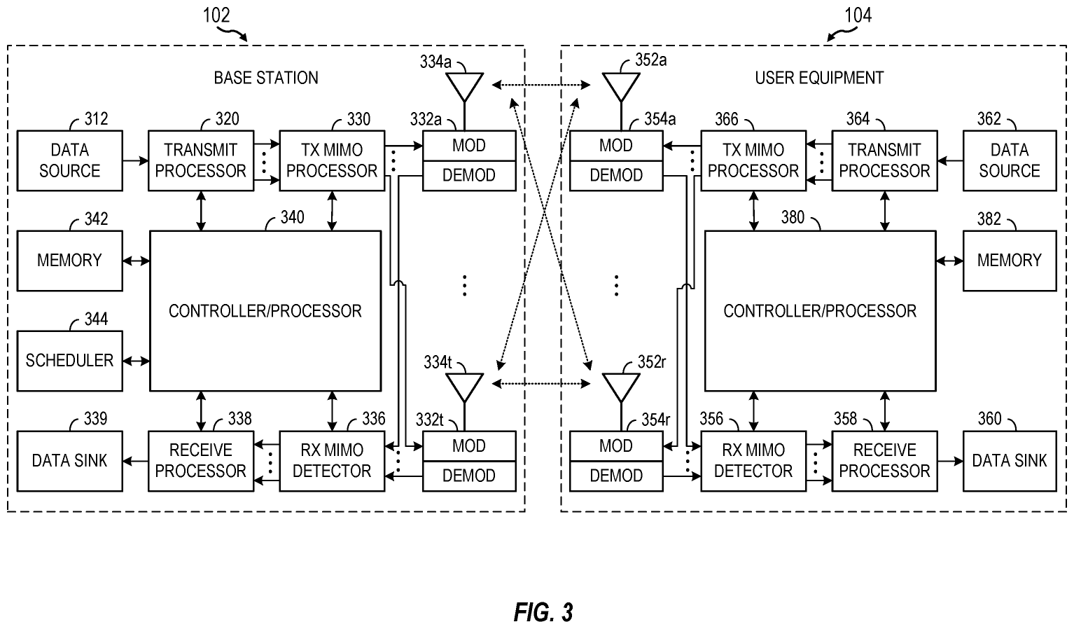

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334at, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

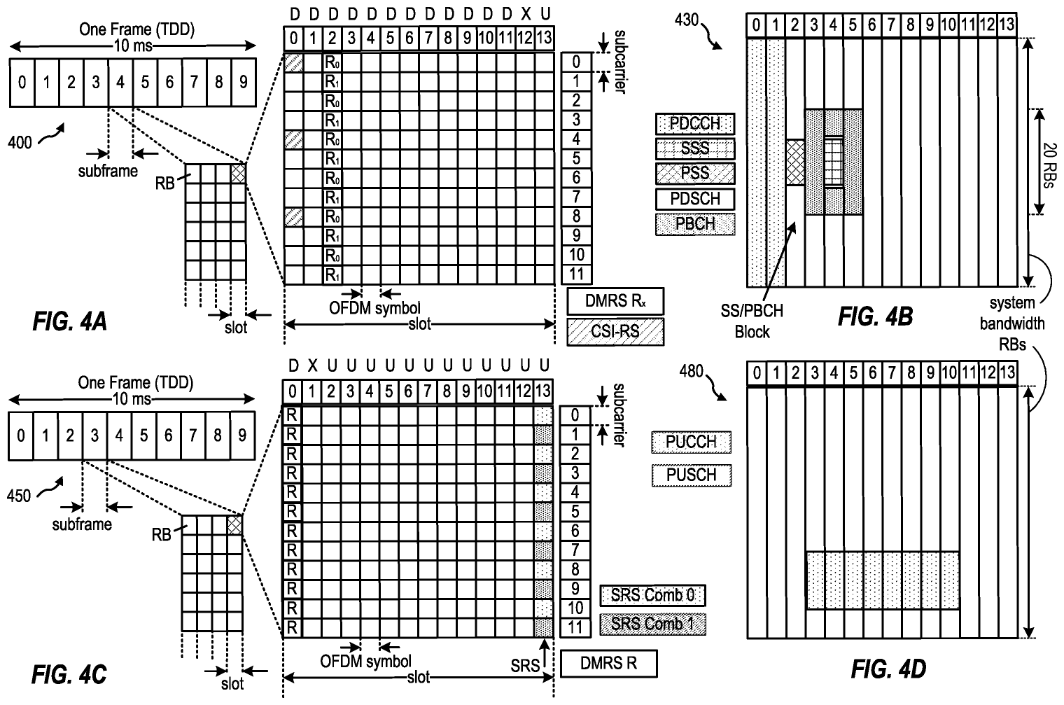

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G( e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there arc 14 symbols/slot and 2μ slots/subframe. The subcarrier spacing and symbol length/duration are a function of the numerology. The subcarrier spacing may be equal to 2″×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### QCL Port and TCI States

In many cases, it is important for a UE to know which assumptions it can make on a channel corresponding to different transmissions. For example, the UE may need to know which reference signals it can use to estimate the channel in order to decode a transmitted signal (e.g., PDCCH or PDSCH). It may also be important for the UE to be able to report relevant channel state information (CSI) to the BS (gNB) for scheduling, link adaptation, and/or beam management purposes. In NR, the concept of quasi co-location (QCL) and transmission configuration indicator (TCI) states is used to convey information about these assumptions.

QCL assumptions are generally defined in terms of channel properties. Per 3GPP TS 38.214, “two antenna ports are said to be quasi-co-located if properties of the channel over which a symbol on one antenna port is conveyed can be inferred from the channel over which a symbol on the other antenna port is conveyed.” Different reference signals may be considered quasi co-located (“QCL'd”) if a receiver (e.g., a UE) can apply channel properties determined by detecting a first reference signal to help detect a second reference signal. TCI states generally include configurations such as QCL-relationships, for example, between the DL RSs in one CSI-RS set and the PDSCH DMRS ports.

In some cases, a UE may be configured with up to M TCI-States. Configuration of the M TCI-States can come about via higher layer signalling, while a UE may be signalled to decode PDSCH according to a detected PDCCH with DCI indicating one of the TCI states. Each configured TCI state may include one RS set TCI-RS-SetConfig that indicates different QCL assumptions between certain source and target signals.

For example, TCI-RS-SetConfig may indicate a source reference signal (RS) is indicated in the top block and is associated with a target signal indicated in the bottom block. In this context, a target signal generally refers to a signal for which channel properties may be inferred by measuring those channel properties for an associated source signal. As noted above, a UE may use the source RS to determine various channel parameters, depending on the associated QCL type, and use those various channel properties (determined based on the source RS) to process the target signal. A target RS does not necessarily need to be PDSCH's DMRS, rather it can be any other RS: PUSCH DMRS, CSIRS, TRS, and SRS.

Each TCI-RS-SetConfig may contain various parameters. These parameters can, for example, configure quasi co-location relationship(s) between reference signals in the RS set and the DM-RS port group of the PDSCH. The RS set contains a reference to either one or two DL RSs and an associated quasi co-location type (QCL-Type) for each one configured by the higher layer parameter QCL-Type.

For the case of two DL RSs, the QCL types can take on a variety of arrangements. For example, QCL types may not be the same, regardless of whether the references are to the same DL RS or different DL RSs. In the illustrated example, SSB is associated with Type C QCL for P-TRS, while CSI-RS for beam management (CSIRS-BM) is associated with Type D QCL.

QCL information and/or types may in some scenarios depend on or be a function of other information. For example, the quasi co-location (QCL) types indicated to the UE can be based on higher layer parameter QCL-Type and may take one or a combination of the following types:
QCL-TypeA: {Doppler shift, Doppler spread, average delay, delay spread },
QCL-TypeB: {Doppler shift, Doppler spread},
QCL-TypeC: {average delay, Doppler shift}, and
QCL-TypeD: {Spatial Rx parameter},
   Spatial QCL assumptions (QCL-TypeD) may be used to help a UE to select an analog Rx beam (e.g., during beam management procedures). For example, an SSB resource indicator may indicate a same beam for a previous reference signal should be used for a subsequent transmission.

An initial CORESET (e.g., CORESET ID 0 or simply CORESET #0) in NR may be identified during initial access by a UE (e.g., via a field in the MIB). A ControlResourceSet information element (CORESET IE) sent via radio resource control (RRC) signaling may convey information regarding a CORESET configured for a UE. The CORESET IE generally includes a CORESET ID, an indication of frequency domain resources (e.g., number of RBs) assigned to the CORESET, contiguous time duration of the CORESET in a number of symbols, and Transmission Configuration Indicator (TCI) states.

As noted above, a subset of the TCI states provide quasi co-location (QCL) relationships between DL RS(s) in one RS set (e.g., TCI-Set) and PDCCH demodulation RS (DMRS) ports. A particular TCI state for a given UE (e.g., for unicast PDCCH) may be conveyed to the UE by the Medium Access Control (MAC) Control Element (MAC-CE). The particular TCI state is generally selected from the set of TCI states conveyed by the CORESET IE, with the initial CORESET (CORESET #0) generally configured via MIB.

Spatial relation information generally refers to an uplink counterpart to TCI. A network may activate and deactivate a spatial relation for a PUCCH resource of a Serving Cell, for example, by sending the PUCCH spatial relation Activation/Deactivation MAC-CE. The network may also activate and deactivate a spatial relation for a PUCCH resource or a PUCCH resource group of a Serving Cell by sending the Enhanced PUCCH spatial relation Activation/Deactivation MAC-CE. The configured spatial relation for a PUCCH resource may be initially deactivated upon (re-) configuration by upper layers and after reconfiguration with sync. The network may also activate and deactivate multiple spatial relations for a PUCCH resource or a PUCCH resource group of a Serving Cell by sending the PUCCH spatial relation Activation/Deactivation for multiple transmitter receiver points (mTRP) via a PUCCH repetition MAC-CE.

In a unified TCI state framework, a DCI/MAC-CE could change the TCI state of a set of uplink and/or downlink channels. One mode for signaling this unified TCI state changes includes a MAC-CE triggered unified TCI state change. Another mode for signaling this unified TCI state is to have a MAC-CE configure several unified TCI states and have DCI indicate one of the multiple TCI states. A general difference between a unified TCI state and a conventional TCI state is that the unified TCI state is jointly configured/activated for multiple channels (either all uplink, all downlink, or mixture of downlink and uplink channels).

### Overview of Search Space (SS) and PDCCH Monitoring Occasions

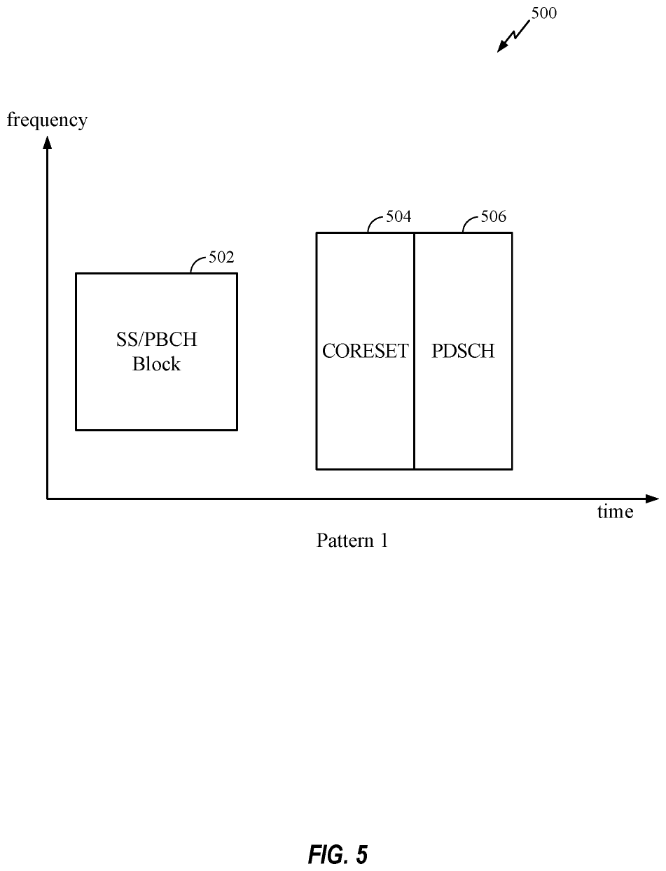

FIG. 5 shows an exemplary transmission resource mapping 500, according to aspects of the present disclosure. In the exemplary mapping, a BS (e.g., BS 110a, shown in FIG. 1) transmits an SS/PBCH block 502. The SS/PBCH block includes a MIB conveying an index to a table that relates the time and frequency resources of the CORESET 504 to the time and frequency resources of the SS/PBCH block.

The BS may also transmit control signaling. In some scenarios, the BS may also transmit a PDCCH to a UE in the (time/frequency resources of the) CORESET. The PDCCH may schedule a PDSCH 506. The BS then transmits the PDSCH to the UE. The UE may receive the MIB in the SS/PBCH block, determine the index, look up a CORESET configuration based on the index, and determine the CORESET from the CORESET configuration and the SS/PBCH block. The UE may then monitor the CORESET, decode the PDCCH in the CORESET, and receive the PDSCH that was allocated by the PDCCH.

Different CORESET configurations may have different parameters that define a corresponding CORESET. For example, each configuration may indicate a number of resource blocks (e.g., 24, 48, or 96), a number of symbols (e.g., 1-3), as well as an offset (e.g., 0-38 RBs) that indicates a location in frequency.

Further, REG bundles may be used to convey CORESETs. REGs in an REG bundle may be contiguous in a frequency and/or a time domain. In certain cases, the time domain may be prioritized before the frequency domain. REG bundle sizes may include: 2, 3, or 6 for interleaved mapping and 6 for non-interleaved mapping.

As noted above, sets of CCEs may be used to transmit new radio PDCCHs (NR-PDCCHs), with different numbers of CCEs in the sets used to transmit NR-PDCCHs using differing aggregation levels. The mapping of PDCCH candidates of an SS set to CCEs of an associated CORESET may be implemented by means of a hash function.

PDCCH monitoring capability may be enhanced to accommodate the shorter slot lengths associated with higher SCS. For higher SCSs (e.g., 480 kHz and 960 kHz), a new PDCCH monitoring capability may be introduced to address the challenges of processing PDCCHs in a short slot duration. As noted above, enhanced monitoring capability may include multi-slot based PDCCH monitoring capability, with a minimum PDCCH monitoring periodicity greater than 1 slot (e.g., as opposed to slot-based PDCCH monitoring with a minimum PDCCH monitoring periodicity of one slot).

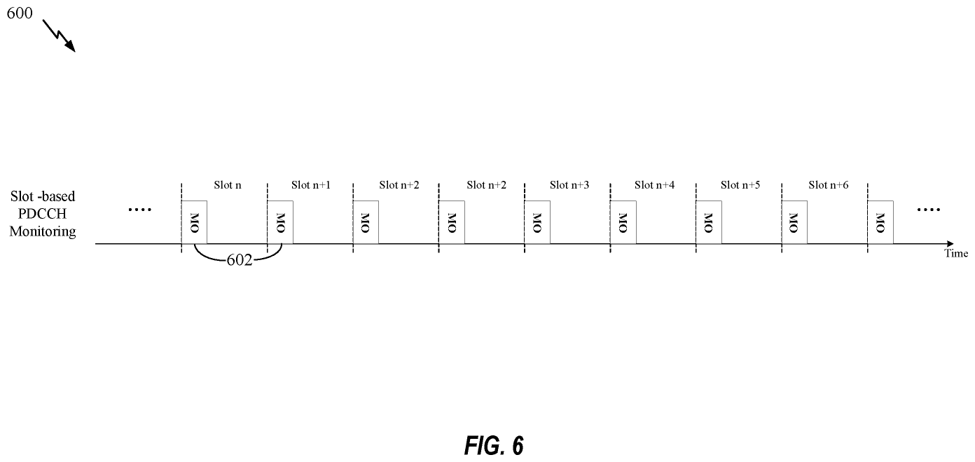

Slot-based PDCCH monitoring capability is illustrated in the example timeline 600 of FIG. 6, where a PDCCH MO 602 occurs in every slot. Some UEs may be capable of multi-slot PDCCH monitoring. For example, based on the UE capability, PDCCH MOs may only occur at least every Xth slot (e.g., X=4) where X is greater than 1, instead of every slot. The supported value(s) of X may depend UE capability.

A base station (BS) (e.g., a gNB) may configure various types of PDCCH search spaces (SSs) for a UE to monitor, including Group 1 or Group 2 SS.

For Group 1 SS, the network may configure Type 1 CSS with a dedicated radio resource control (RRC) configuration and Type 3 CSS and UE-specific search spaces (USS). An SS may be monitored within Y consecutive slots within a slot group of X slots. The Y consecutive slots may be located anywhere within the slot group of X slots. Y consecutive slots may or may not be aligned across UEs or with slot n0. The location of the Y consecutive slots within the slot group of X slots is maintained across different slot groups. Blind decoding (BD) attempts for all Group 1 SSs may fall within the same Y consecutive slots.

For a Group 2 SS, there may be a Type 1 CSS without a dedicated RRC configuration. There may also be Type 0, Type OA, and Type 2 CSS. In this case, SS monitoring locations may be anywhere within a slot group of X slots, with the following exception. BD attempts for Type0-CSS for SSB/CORESET 0 multiplexing pattern 1 and, additionally, for Type0A/2-CSS if searchSpaceId=0 (SS set #0), occur in slots with index n0 and n0+X0, where n0 may be defined by current wireless operating standards (e.g., where X0=4 for 480 kHz, and X0-8 for 960 kHz SCS).

### Aspects Related to UCI Enhancement

Aspects of the present disclosure provide apparatuses, methods, processing systems, and computer-readable mediums for enhanced UCI transmission. As noted above, in some cases, a UCI transmission may be used to terminate a power savings mode, such as PDCCH skipping or search space set group (SSSG) switching.

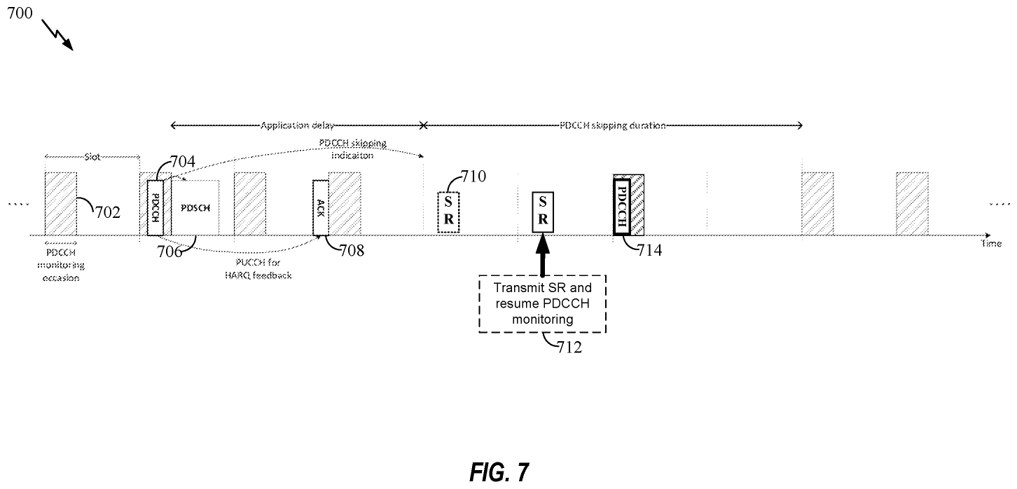

FIG. 7 illustrates an example timeline 700 for skipping PDCCH monitoring occasions (MOs) 702. In the illustrated example, a network entity (e.g., a gNB) dynamically indicates, via PDCCH 704 scheduling a PDSCH 706. The UE may begin skipping PDCCH MOs after an application delay, which allows for the UE to send an acknowledgment (ACK 708) for PDSCH 706 on a PUCCH resource. The UE may be configured to perform PDCCH skipping for a given PDCCH skipping duration (e.g., an amount of time or a period in terms of a number of slots).

As noted above, one tradeoff to the power savings achieved via PDCCH skipping is that a latency penalty may be incurred, as the UE does not receive scheduling DCI during the PDCCH skipping duration. As noted above, in order to reduce this latency, the UE may be configured with a PUCCH resource 710 that allows the UE to send uplink control information (UCI) to terminate the PDCCH skipping prior to an end of the PDCCH skipping duration. For example, as illustrated at 712, the UE may send an SR and resume PDCCH monitoring. A UE may terminate PDCCH skipping, for example, if it has urgent uplink data. This early termination may allow the UE to receive an uplink grant via a PDCCH 714, without having to wait until the end of the PDCCH skipping duration, thereby reducing latency.

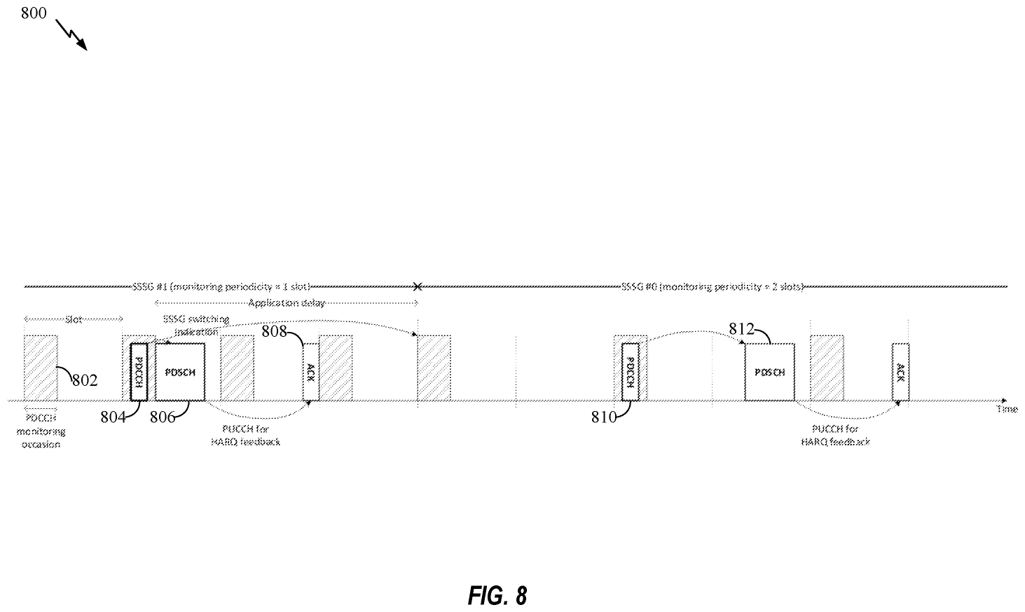

FIG. 8 illustrates an example timeline 800 for SSSG switching. In the illustrated example, a network entity (e.g., a gNB) dynamically indicates, via PDCCH 804 scheduling a PDSCH 806. The switch may be from a first SSSG (SSSG #1) to a second SSSG (SSSG #2) having less frequency PDCCH MOs 802. In the illustrated example, the PDCCH MO periodicity is 1 slot in SSSG #1 and 2 slots in SSSG #2. Thus, after switching to SSSG #2, the UE may still receive a PDCCH 810 scheduling a PDSCH 812, but with the potential latency due to the less frequent PDCCH MOs. An SR overriding scheme, similar to that described above with reference to PDCCH skipping, may also be used to override SSSG switching.

To exploit the latency reduction benefit of such an SR overriding scheme, it may be beneficial to configure the UE with PUCCH resources (e.g., for SR transmission) with a relatively small periodicity (e.g., 1 or 2 slots.) However, this may be problematic for certain frequency bands, such as FR2, with highly directional signal properties. For example, in such cases, each SR transmission may have its own beam, and the network entity (e.g., gNB) may not be able to monitor SRs from two different UEs at the same time (e.g., on the same OFDM symbol), if the two UEs transmit SR from different beam directions. The gNB can only monitor the two SRs (from different UEs) with different beam directions using time division multiplexing (TDM). In other words, the gNB can only schedule the two SRs from UEs in different beam directions on different OFDM symbols, even though each SR may only consume 1 resource block (RB) in the frequency domain.

This may be very inefficient in terms of system resource utilization/allocation. To try and optimize the resource utilization efficiency, it may be desirable for the gNB to try and configure uplink resources for SRs from UEs in the same beam direction on the same OFDM symbol (e.g., to align the SR transmissions from different UEs based on their corresponding beam direction). Because the gNB does not know when a UE will transmit a SR, the gNB may dedicate resources for all SR monitoring occasions.

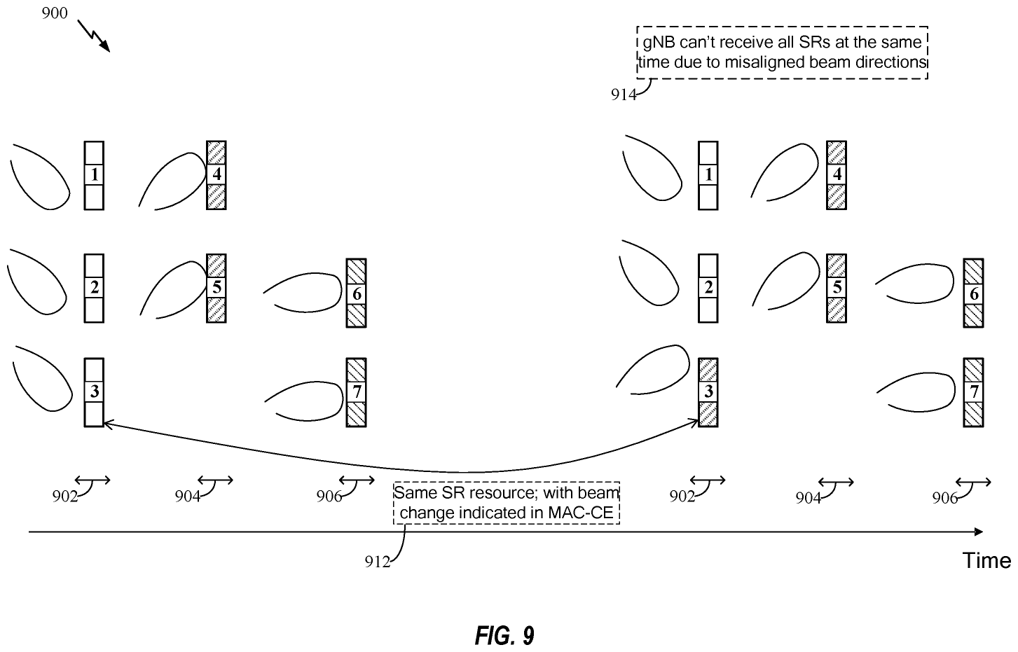

The diagram 900 of FIG. 9 illustrates an example of how a gNB may align for SRs from UEs in the same beam direction on the same OFDM symbol. In the illustrated example, SRs from a first set of UEs (UE 1, UE 2, and UE 3) are aligned in a first OFDM symbol 902, SRs from a second set of UEs (UE 4 and UE 5) are aligned in a second OFDM symbol 904, while SRs from a third set of UEs (UE 6 and UE 7) are aligned in a third OFDM symbol 906.

As noted above, however, a UE may change its location or orientation (e.g., due to mobility or handset rotation) bringing that UE out of alignment, which may impact its ability to quickly send an SR to override a power savings mode. In the example illustrated in FIG. 9, UE 3 has changes its location or orientation. As shown at 912, the network may issue a beam switch command via a medium access control (MAC) control clement (CE) or DCI to address this issue, but the UE may have the same PUCCH resource to send SR. As indicated at 914, the gNB may not be able to receive all SRs at the same time (in symbol 902) due to the misaligned beam directions (e.g., with different PUCCH spatial relation or TCI states). As a result, there may be a delay in the UE being able to send the SR, offsetting some of the latency reduction intended by overriding the power saving mode.

Aspects of the present disclosure may help address this issue, however, by coordinating PUCCH resource updates with a beam switch. Utilizing the mechanisms described herein, PUCCH (e.g., SR) resources may be updated at the same pace as beam updates. As a result, a UE may be able to exit a power saving mechanism sooner, reducing latency and improving overall system performance.

The mechanism proposed herein may allow for a PUCCH resource change to be indicated via additional signaling (e.g., dynamic signaling, such as MAC-CE or DCI), rather than RRC signaling which is much slower. In some cases, a UE may be configured with PUCCH resources via RRC signaling, with updates provided via dynamic signaling (e.g., in conjunction with a beam switch).

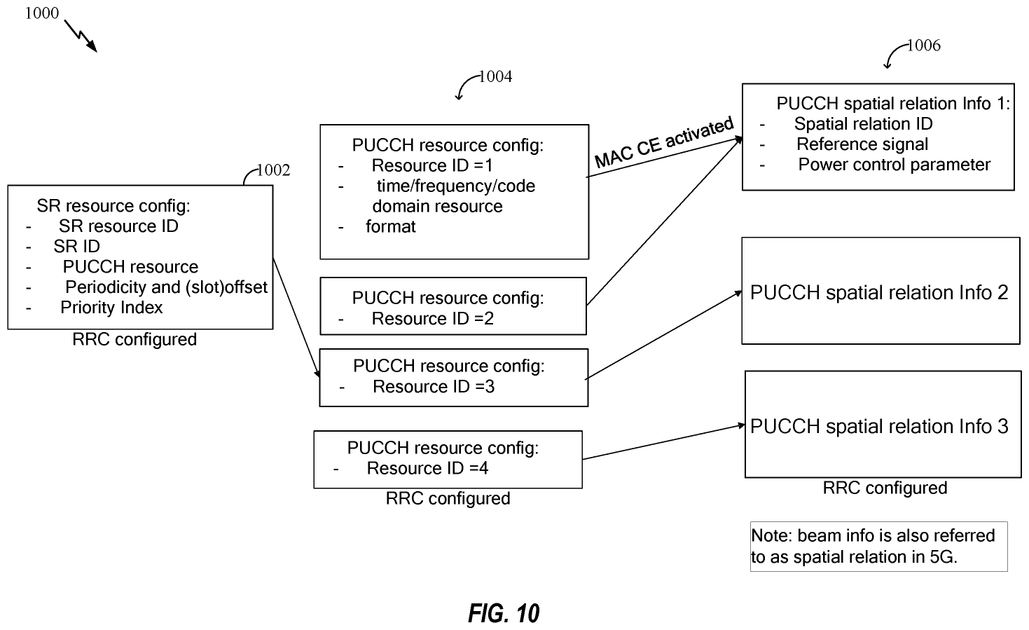

FIG. 10 illustrates an example of RRC based PUCCH resource configuration and spatial relation configuration for SR. As shown at 1002, an SR resource configuration may indicate various parameters, such as an SR resource ID, SR ID, PUCCH resource, periodicity and (slot) offset, and priority index. Examples of PUCCH resource configurations (with Resource IDs 1-4) are shown at 1004. Once RRC configured, a particular beam may be chosen via a particular PUCCH spatial relation information 1006, and may be activated via a MAC-CE.

As used herein, a transmission configuration indicator (TCI) state may refer to a specific beam, or a specific spatial relation (e.g., associated with a reference signal). As such, the terms “TCI state,” “beam,” and “spatial relation” may be used interchangeably. For example, a beam change may refer to TCI state change or spatial relation change.

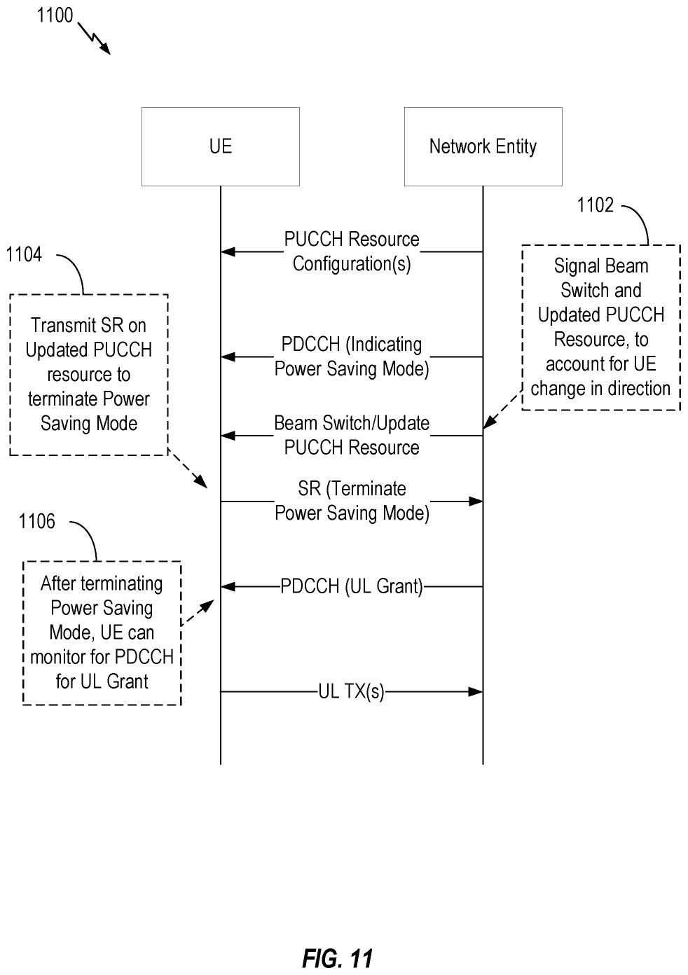

Enhanced UCI transmission proposed herein, that allow for a PUCCH resource change to be indicated via dynamic signaling (e.g., MAC-CE or DCI), may be understood with reference to the call flow diagram 1100 of FIG. 11. In some aspects, the network entity shown in FIG. 11 may be an example of the BS depicted and described with respect to FIGS. 1 and 3 or a disaggregated base station depicted and described with respect to FIG. 2. Similarly, the UE shown in FIG. 11 may be an example of UE 104 depicted and described with respect to FIGS. 1 and 3.

As shown, the UE may be configured, via first signaling (e.g., RRC signaling), with at least one physical uplink control channel (PUCCH) resource. The UE may be placed in a power saving mode, such as PDCCH skipping and/or SSSG switching, via a PDCCH.

As indicated at 1102, MAC-CE the network entity may signal, via second signaling (e.g., dynamic signaling via a DCI or MAC-CE), a beam switch (to a new beam) and updated PUCCH resource, to account for a change in UE direction. As indicated at 1104, the UE may transmit an SR on the updated PUCCH resource (using the new beam) to terminate the power saving mode. As indicated at 1106, the UE may then monitor for a PDCCH (e.g., carrying DCI) for an uplink grant, allowing the UE to send uplink transmissions sooner than if it had not terminated the power saving mode.

In essence, aspects of the present disclosure may help coordinate PUCCH resource updates with a beam switch. Utilizing the mechanisms described herein, PUCCH (e.g., SR) resources (e.g., at least time domain resource/symbol) may be updated at the same pace as beam updates. As in the example described above, a UE may be able to exit a power saving mechanism sooner, reducing latency and improving overall system performance.

Updating PUCCH resources to send an SR transmission is just one example of how a PUCCH resource update may be used. The techniques proposed herein may be generally applied to update PUCCH resources used for transmitting other types of UCI, such as acknowledgment (ACK) feedback or channel state information (CSI).

A PUCCH resource update may be signaled via layer 1 (L1) signaling (e.g., a new or existing DCI format), layer 2 (L2) signaling (e.g., a new or existing MAC-CE format), or a combination thereof. For example, a MAC-CE may be used to down-select a subset of PUCCH resources from a larger set of RRC configured PUCCH resources, while a DCI may be used to indicate a particular PUCCH resource from the subset. In some cases, the update to the PUCCH resource may be indicated in conjunction with a beam switch (e.g., at the same time, before, or just after), so UCI can be transmitted on the PUCCH resource using a new beam. As will be described in detail below, an update to a PUCCH resource may mean applying an offset to the PUCCH resource (e.g., to a different time domain resource/symbol) to align with PUCCH resources for other UEs. An update to a PUCCH resource may also mean changing to a different PUCCH resource (e.g., with a different PUCCH resource ID).

According to certain aspects, dynamic signaling (L1/L2) from a network entity (e.g., a gNB) to a UE may indicate an update to the slot offset of a SR resource within an SR period. In some cases, the network may indicate an update to the PUCCH resource (e.g., PUCCH resource ID) associated with an SR resource configuration.

In some cases, the signaling may indicate an update to one or more of the time domain, frequency domain, or code domain resource allocation configuration of a PUCCH resource. This update may be signaled by indicating one or more parameters, such as a starting symbol index, a number of symbols (nrofSymbols), a starting physical resource block (PRB), a number of PRBs (nrofPRBs), an initial cyclic shift (initialCyclicShift), a time domain orthogonal cover code (timedomainOCC), a PUCCH format (e.g., format 0->1 vs format 1->0), a PUCCH repetition factor, an interlace allocation (e.g., for NR unlicensed applications), or frequency hopping parameters (e.g., to enable/disable hopping, and/or specify a 2nd hop PRB index).

As noted above, a PUCCH update may be indicated via L1 signaling, L2 signaling or combination thereof. In some cases, a MAC-CE may provide a set of choices of options of parameters/configurations, while lower layer signaling (e.g., a PDCCH) may be used to activate a specific set of configurations/parameters.

In some cases, the network may use a mask to indicate valid occasions for SR transmission among a set configured SR occasions. For example, if SR is configured every N slots, the network may dynamically indicate every 2N slots are usable. In some cases, the network may configure an SR occasion every N slots. In such cases, the gNB may dynamically indicate a subset of these N slots as available and the rest as unavailable/un-useable. This way, by indicating which subset is usable and which subset is not usable, the gNB may dynamically change the time-domain location/pattern/offset of the SR transmission. This approach may provide flexibility, as the gNB may indicate more complicated patterns than a simple offset. This approach may allow the network to avoid spatial collision, although latency of SR may be increased for a specific users.

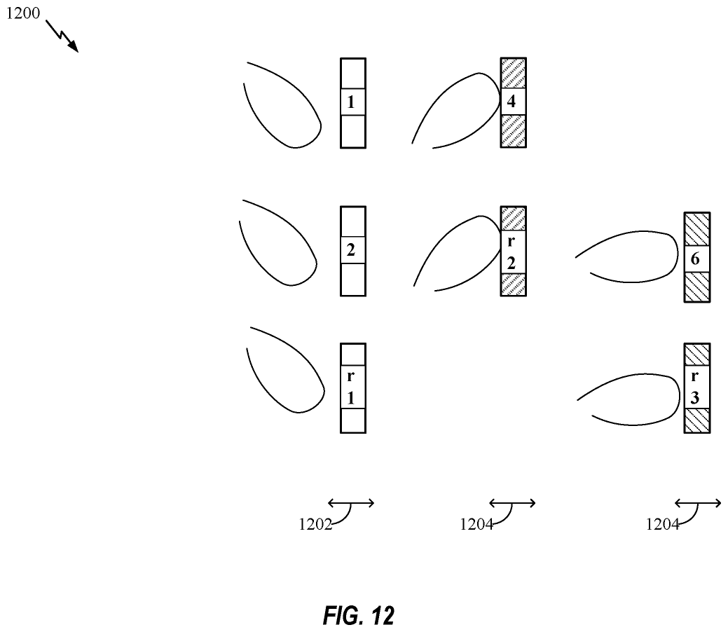

As illustrated in FIG. 12, a gNB could pre-configure multiple PUCCH resources with different beams for a UE, and the alignment of the beams from different UEs can be achieved in a semi-static manner. In the illustrated example, a UE (e.g., UE3) may be configured with 3 PUCCH resources: r1 is slot 1202, r2 in slot 1204 and r3 in slot 1206. With this configuration, a beam change and PUCCH resource change may be indicated at the same time. In other words, as illustrated, each of the configured resources may be associated with a different beam aligned with other UEs in the same symbol.

As an example, UE3 may initially be aligned with UE1 and UE2 and, therefore, configured with PUCCH resource r1. If UE3 changes position/orientation such that its direction aligns more with UE4 than UE1 and UE2, the network may signal UE3 an update to PUCCH resource r2 and the associated beam. Similarly, if UE3 changes position/orientation such that its direction aligns more with UE6, the network may signal UE3 an update to PUCCH resource r3 and the associated beam.

According to certain aspects, an existing spatial relation/TCI state update via MAC-CE may be reused to indicate a PUCCH resource update associated with a UCI (e.g., SR) transmission in conjunction with a beam change. In such cases, each configured spatial relation information/TCI state may be associated with an offset, for example, in one or more of the time-domain (in terms of symbols and/or slots), the frequency domain, or the code domain (e.g., an OCC or cyclic shift). In such cases, when the UE receives the spatial relation/TCI state update MAC-CE, the UE applies the (time/frequency/code domain) offset(s) to the corresponding PUCCH resource, together with the spatial relation/TCI state update (beam switch).

In some cases, the gNB may configure, for each TCI state/spatial relation, a list of PUCCH resources for SR (and/or other UCIs, e.g., HARQ-ACK for SPS PDSCH, CSI reports). Each PUCCH resource in the list may be associated with an SR configuration. When the UE receives a TCI state update via a MAC-CE/DCI, the SR PUCCH resources may all be updated to the ones associated with the updated TCI state.

In some cases, the offset value(s) may be PUCCH resource specific. In other words, different sets of offset values may be configured for different PUCCH resources and the UE may apply the corresponding offset (values) associated with both the TCI state/spatial relation and the PUCCH resource. In other cases, offset value(s) may be TCI state/spatial relation specific. In other words, a common set of time/frequency/code domain offset values may be configured for a given TCI state/spatial relation, regardless of which PUCCH resource is used. In some cases, RRC signaling may be used to configure corresponding time/frequency/code domain offset values.

In general, for the various schemes described herein, a new RRC configuration (from gNB to UE) may be introduced to indicate whether the enhanced SR/UCI transmission procedure is enabled or not. In other words, the UE may apply the PUCCH resource update only if the UE is configured by the gNB, in order to perform the enhanced SR/UCI transmission procedure.

Further, in some cases, the UE may also determine whether to enable the enhanced SR/UCI transmission or not, based on whether there are offset values or PUCCH resources configured for a TCI state/spatial relation. In other words, if no offset/PUCCH resource is configured for a TCI-state/spatial relation, then the UE may not update the PUCCH resource.

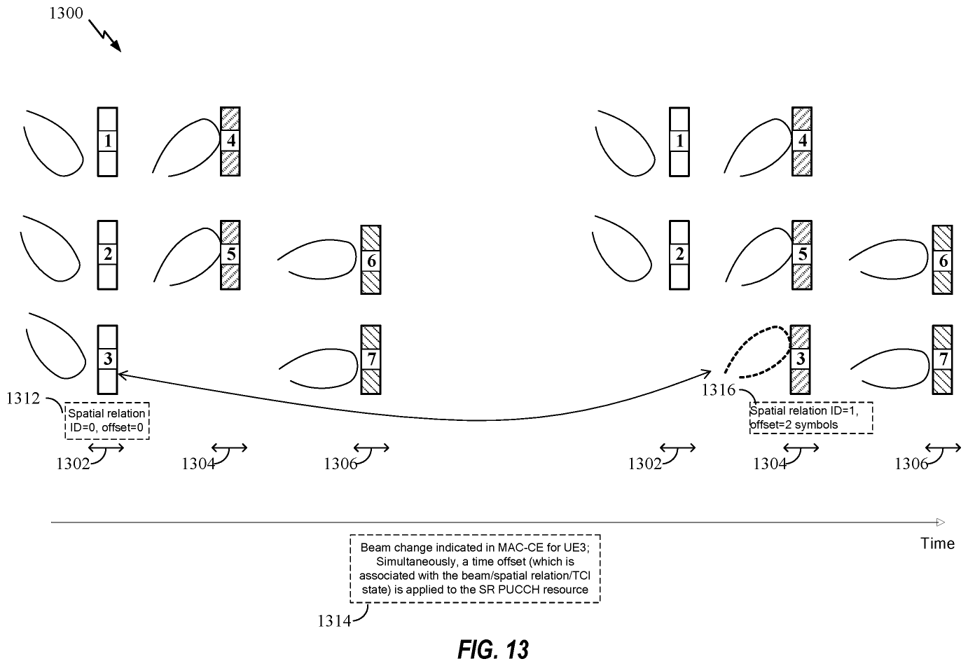

FIG. 13 illustrates an example of how dynamic signaling (e.g., a MAC-CE and/or DCI) may be used to indicate a beam change and PUCCH resource update in the manner described above. In the illustrated example, UE3 is initially aligned with UE1 and UE2. As indicated at 1312, UE3 may have a PUCCH resource in slot 1302 corresponding to spatial relation ID of 0 and an offset value of 0.

As indicated at 1314, a beam change may be indicated via dynamic signaling for UE3, which may simultaneously indicate a time offset (e.g., which is associated with the beam/spatial relation/TCI state) to be applied to the SR PUCCH resource. For example, the MAC-CE may indicate a spatial relation ID of 1, which has a corresponding PUCCH resource corresponding to an offset in the time domain of 2 symbols (as indicated at 1316), aligning UE3 with UE4 and UE5 in symbol 1304.

In some cases the MAC-CE that indicates the beam change could include various parameters to indicate a PUCCH resource update. In some cases, the MAC-CE could be a PUCCH spatial relation Activation/Deactivation MAC-CE, an enhanced PUCCH Spatial Relation Activation/Deactivation MAC-CE, a PUCCH spatial relation Activation/Deactivation for multiple TRP PUCCH repetition MAC-CE, or a unified TCI States Activation/Deactivation MAC-CE (e.g., that activates/deactivates TCI states applied to multiple reference signals).

In addition to the MAC-CE, in some cases, the UE may receive a DCI to indicate a TCI state change for the PUCCH resource for SR. In this case, simultaneous/joint update of a beam and PUCCH resource may be applied, where the UE applies the offset value(s) associated with the TCI state to the PUCCH resource along with the TCI state change. The DCI may be any suitable type of DCI format that includes a TCI state, which could be used by the UE to change the TCI state of PUCCH.

As noted above, the techniques described herein may be generally applied to a variety of UCI types, with SR being just one example. In some case, a MAC-CE used to indicate a PUCCH resource update may be limited to a subset of PUCCH formats (e.g., only to PUCCH format 0 and 1). This approach may be used to change the PUCCH resource for various types of UCIs, such as hybrid automatic repeat request (HARQ) acknowledgment (ACK) for a dynamic grant (DG) or semi-persistent scheduling (SPS) PDSCH, periodic or semi-persistent (P/SP)-CSI on PUCCH. In some cases, a new MAC-CE and/or DCI may be used to change the PUCCH resource for SPS HARQ-ACK and/or for P/SP CSI report (on PUCCH).

According to certain aspects, new L1/L2 signaling from the gNB to the UE may be introduced to indicate updates according to various options. For example, according to a first option, the PUCCH resource (ID) associated with an SPS configuration may be updated (e.g., to update/overwrite the PUCCH resource configured in nlPUCCH-AN). According to a second option, the PUCCH resource(s) configured in sps-PUCCH-AN-List in the pucch-config may be activated/de-activated. This approach may be used to indicate PUCCH resources used by the UE when there is more than one downlink SPS PDSCH configured in to the UE. According to another option, the PUCCH resource(s) configured in multi-CSI-PUCCH-ResourceList may be activated/de-activated. According to still another option, the PUCCH resource(s) associated with a CSI-ReportConfig may be activated/de-activated.

Various MAC-CE formats, with different content, may also be used to indicate updates in the manners proposed herein. According to a first option, a MAC-CE may include a Serving cell ID, BWP ID, SR resource ID, and slot offset. According to a second option, a MAC-CE may include a Serving cell ID, bandwidth part (BWP) ID, SR resource ID, and PUCCH resource ID. According to a third option, a MAC-CE may include a Serving cell ID, BWP ID, PUCCH resource ID, and new resource allocation parameters.

In some cases, a MAC-CE may include a Serving cell ID, BWP ID, an SPS configuration ID, and a PUCCH resource ID associated with the SPS configuration. In some cases, a MAC-CE may include a Serving cell ID, BWP ID, and one or more PUCCH resource ID(s). In some cases, a MAC-CE may include a Serving cell ID, BWP ID, CSI-Report Config, and PUCCH resource ID. In addition, a unified MAC-CE format may be defined for all above, and therefore, the MAC-CE may also indicate the type of MAC-CE (e.g., according to one of the options described above).

There are various options for how a UE behavior upon receiving a MAC-CE and/or DCI indicating a PUCCH resource update. For example, upon receiving the MAC-CE indicating the PUCCH resource update, the UE may indicate certain information about the update to lower layers (L1/L2), and override the RRC configuration with the updated information after a MAC-CE action time. For example, the MAC action time may be a fixed time (e.g., 3 ms) after sending a HARQ-ACK associated with the PDSCH containing the MAC-CE.

In some cases, semi-persistent SR scheduling may be used, which may be more resource efficient than an SR design where a SR resource configuration is always indicated by RRC. In this case, a faster mechanism may be used to enable/disable SR transmission. For example, a MAC-CE or L1 signaling (e.g., via a PDCCH/DCI) may be used to activate/deactivate SR transmission on PUCCH. In such cases, a gNB may configure the parameters for each SR configuration (e.g., including periodicity, SR ID, and SR resource ID) via RRC, and indicate that a particular SR configuration needs activation using MAC-CE. In other words, the MAC-CE may activates/deactivate the corresponding SR configuration. In some cases, the MAC-CE may additionally indicate the PUCCH resource for the activated SR configuration.

As noted above, the techniques described herein may be applied in a variety of scenarios to enhance UCI transmissions, including enhancing SR transmission to terminate power savings features in FR2 deployments, or any other types of UCI transmissions noted above. The techniques may also be applied in other frequency range deployments, such as FR1, in case there is a benefit to aligning the pace of beam updates with PUCCH resource updates. The techniques may help meet latency objectives/requirements in various applications, such as ultra-reliable low latency communications (URLLC) and industrial Internet of things (IIoT) applications.

The techniques described herein may allow the network to activate and deactivate a spatial relation for a PUCCH resource of a Serving Cell by sending the PUCCH spatial relation Activation/Deactivation MAC-CEMAC-CE. The network may also activate and deactivate a spatial relation for a PUCCH resource or a PUCCH resource group of a Serving Cell by sending the Enhanced PUCCH spatial relation Activation/Deactivation MAC-CEMAC-CE. The configured spatial relation for a PUCCH resource may initially be deactivated upon (re-)configuration by upper layers and after reconfiguration with sync. The network may also activate and deactivate multiple spatial relations for a PUCCH resource or a PUCCH resource group of a Serving Cell by sending a PUCCH spatial relation Activation/Deactivation for a multiple transmitter receiver point (mTRP) PUCCH repetition MAC-CEMAC-CE.

### Example Operations

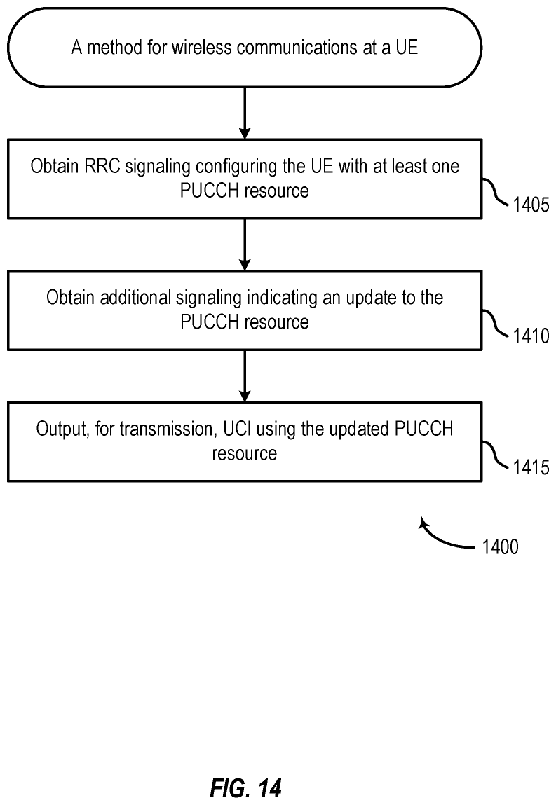

FIG. 14 shows an example of a method 1400 of wireless communications at a UE, such as a UE 104 of FIGS. 1 and 3.

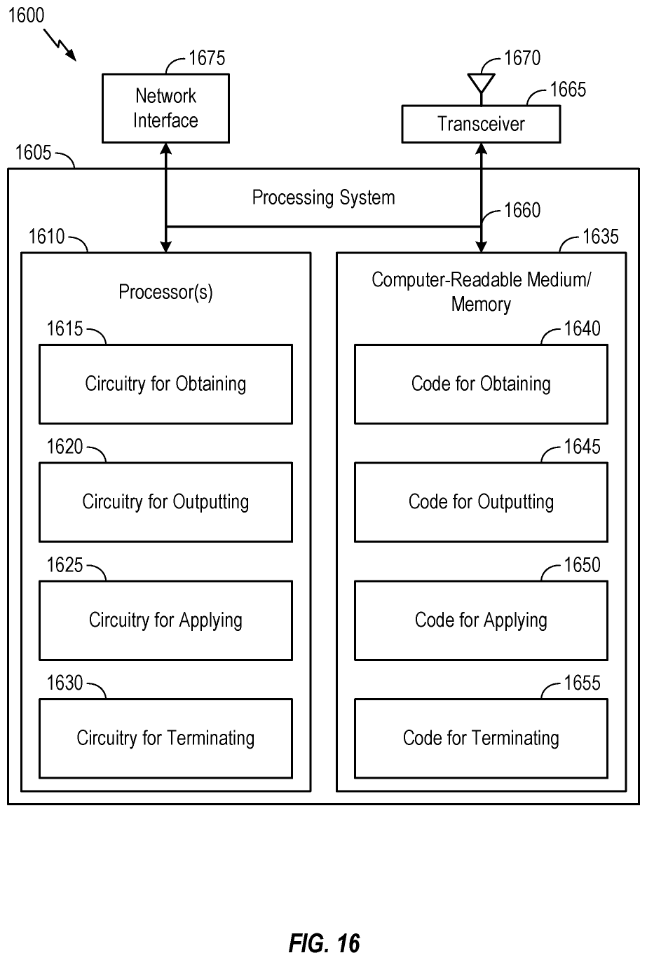

Method 1400 begins at step 1405 with obtaining RRC signaling configuring the UE with at least one PUCCH resource. In some cases, the operations of this step refer to, or may be performed by, circuitry for obtaining and/or code for obtaining as described with reference to FIG. 16.

Method 1400 then proceeds to step 1410 with obtaining additional signaling indicating an update to the PUCCH resource. In some cases, the operations of this step refer to, or may be performed by, circuitry for obtaining and/or code for obtaining as described with reference to FIG. 16.

Method 1400 then proceeds to step 1415 with outputting, for transmission, UCI using the updated PUCCH resource. In some cases, the operations of this step refer to, or may be performed by, circuitry for outputting and/or code for outputting as described with reference to FIG. 16.

In some aspects, the UCI comprises a SR.

In some aspects, the SR is output for transmission to terminate a power saving mode.

In some aspects, the power saving mode involves at least one of PDCCH skipping or SSSG switching.

In some aspects, the additional signaling indicates the update to the PUCCH resource via an updated slot offset or a PUCCH resource ID.

In some aspects, the additional signaling indicates an update to at least one of: a time domain resource allocation of the PUCCH resource; a frequency domain resource allocation of the PUCCH resource; or a code domain resource allocation configuration of the PUCCH resource.

In some aspects, the additional signaling comprises at least one of: a PDCCH or a MAC-CE.

In some aspects, the MAC-CE indicates a set of options for updating the PUCCH resource; and the PDCCH indicates one of the set of options.

In some aspects, the method 1400 further includes obtaining signaling configuring the UE with PUCCH occasions, wherein the additional signaling indicates the update to the PUCCH resource as an indication of valid occasions for PUCCH transmission among configured PUCCH occasions. In some cases, the operations of this step refer to, or may be performed by, circuitry for obtaining and/or code for obtaining as described with reference to FIG. 16.

In some aspects, the additional signaling indicates an update to the PUCCH resource to use in conjunction with a beam switch to a new beam; and the UCI is output, for transmission, using the new beam.

In some aspects, the additional signaling also indicates the beam switch.

In some aspects, the method 1400 further includes obtaining signaling configuring the UE with multiple PUCCH resources associated with different beams, wherein the additional signaling indicates the update to the PUCCH resource and the beam switch by identifying one of the multiple PUCCH resources. In some cases, the operations of this step refer to, or may be performed by, circuitry for obtaining and/or code for obtaining as described with reference to FIG. 16.

In some aspects, the method 1400 further includes obtaining signaling configuring the UE with multiple TCI states, each associated with an offset in at least one of: a time domain, a frequency domain, or a code domain, wherein the additional signaling indicates the update to the PUCCH resource and the beam switch by identifying one of the TCI states. In some cases, the operations of this step refer to, or may be performed by, circuitry for obtaining and/or code for obtaining as described with reference to FIG. 16.

In some aspects, the method 1400 further includes applying the offset to update the PUCCH resource. In some cases, the operations of this step refer to, or may be performed by, circuitry for applying and/or code for applying as described with reference to FIG. 16.

In some aspects, the UCI comprises at least one of a HARQ ACK feedback or CSI.

In some aspects, the additional signaling indicates at least one of: an update to a PUCCH resource ID associated with a SPS configuration for the HARQ ACK feedback; activation or deactivation of at least one PUCCH resource configured in an SPS PUCCH HARQ ACK feedback list; activation or deactivation of one or more PUCCH resource configured in a multiple CSI PUCCH resource list; or at least one PUCCH resource associated with a CSI report configuration.

In some aspects, the additional signaling conveys parameters including one or more of: a MAC-CE that includes at least one of: a serving cell ID, a BWP ID, a SR ID, a slot offset, a PUCCH resource ID, or a MAC-CE type indicating what parameters are included in the MAC-CE.

In some aspects, the UE applies the update to the PUCCH resource an action time after acknowledging the additional signaling.

In some aspects, the UCI comprises a SR; the update to the PUCCH resource comprises an update to an SR resource; and the additional signaling indicates an update to the SR resource by activating or deactivating SR transmission according to an SR configuration.

In one aspect, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative steps are possible consistent with this disclosure.

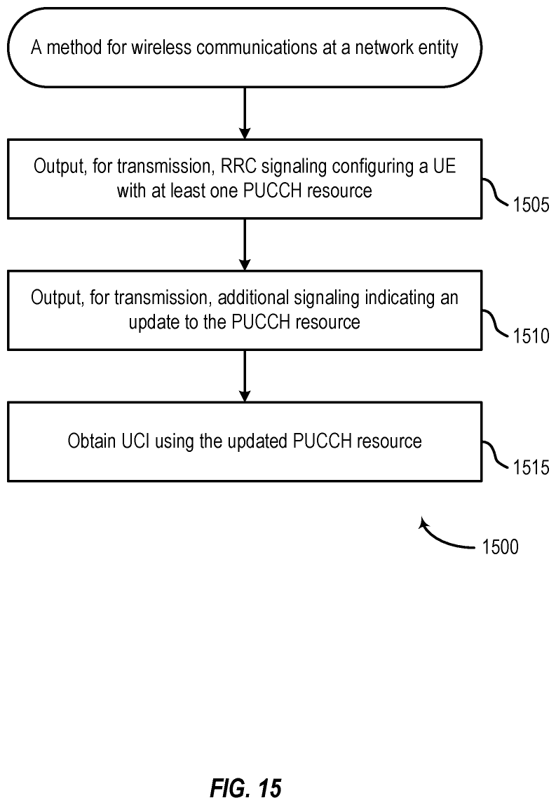

FIG. 15 shows an example of a method 1500 of wireless communications at a network entity, such as a BS 102 of FIGS. 1 and 3, or a disaggregated base station as discussed with respect to FIG. 2.

Method 1500 begins at step 1505 with outputting, for transmission, RRC signaling configuring a UE with at least one PUCCH resource. In some cases, the operations of this step refer to, or may be performed by, circuitry for outputting and/or code for outputting as described with reference to FIG. 16.

Method 1500 then proceeds to step 1510 with outputting, for transmission, additional signaling indicating an update to the PUCCH resource. In some cases, the operations of this step refer to, or may be performed by, circuitry for outputting and/or code for outputting as described with reference to FIG. 16.

Method 1500 then proceeds to step 1515 with obtaining UCI using the updated PUCCH resource. In some cases, the operations of this step refer to, or may be performed by, circuitry for obtaining and/or code for obtaining as described with reference to FIG. 16.

In some aspects, the UCI comprises a SR.

In some aspects, the method 1500 further includes terminating a power saving mode of the UE after obtaining the SR. In some cases, the operations of this step refer to, or may be performed by, circuitry for terminating and/or code for terminating as described with reference to FIG. 16.

In some aspects, the power saving mode involves at least one of PDCCH skipping or SSSG switching.

In some aspects, the additional signaling indicates the update to the PUCCH resource via an updated slot offset or a PUCCH resource ID.

In some aspects, the additional signaling indicates an update to at least one of: a time domain resource allocation of the PUCCH resource; a frequency domain resource allocation of the PUCCH resource; or a code domain resource allocation configuration of the PUCCH resource.

In some aspects, the additional signaling comprises at least one of: a PDCCH or a MAC-CE.

In some aspects, the MAC-CE indicates a set of options for updating the PUCCH resource; and the PDCCH indicates one of the set of options.

In some aspects, the method 1500 further includes outputting, for transmission, signaling configuring the UE with PUCCH occasions, wherein the additional signaling indicates the update to the PUCCH resource as an indication of valid occasions for PUCCH transmission among configured PUCCH occasions. In some cases, the operations of this step refer to, or may be performed by, circuitry for outputting and/or code for outputting as described with reference to FIG. 16.

In some aspects, the additional signaling indicates an update to the PUCCH resource to use in conjunction with a beam switch to a new beam.

In some aspects, the additional signaling also indicates the beam switch.

In some aspects, the method 1500 further includes outputting, for transmission, signaling configuring the UE with multiple PUCCH resources associated with different beams, wherein the additional signaling indicates the update to the PUCCH resource and the beam switch by identifying one of the multiple PUCCH resources. In some cases, the operations of this step refer to, or may be performed by, circuitry for outputting and/or code for outputting as described with reference to FIG. 16.

In some aspects, the method 1500 further includes outputting, for transmission, signaling configuring the UE with multiple TCI states, each associated with an offset in at least one of: a time domain, a frequency domain, or a code domain, wherein the additional signaling indicates the update to the PUCCH resource and the beam switch by identifying one of the TCI states. In some cases, the operations of this step refer to, or may be performed by, circuitry for outputting and/or code for outputting as described with reference to FIG. 16.

In some aspects, the method 1500 further includes applying the offset to update the PUCCH resource. In some cases, the operations of this step refer to, or may be performed by, circuitry for applying and/or code for applying as described with reference to FIG. 16.

In some aspects, the UCI comprises at least one of a HARQ ACK feedback or CSI.

In some aspects, the additional signaling indicates at least one of: an update to a PUCCH resource ID associated with a SPS configuration for the HARQ ACK feedback; activation or deactivation of at least one PUCCH resource configured in an SPS PUCCH HARQ ACK feedback list; activation or deactivation of one or more PUCCH resource configured in a multiple CSI PUCCH resource list; or at least one PUCCH resource associated with a CSI report configuration.

In some aspects, the additional signaling conveys parameters including one or more of: a MAC-CE that includes at least one of: a serving cell ID, a BWP ID, a SR ID, a slot offset, a PUCCH resource ID, or a MAC-CE type indicating what parameters are included in the MAC-CE.

In some aspects, the method 1500 further includes obtaining acknowledgement of the additional signaling from the UE. In some cases, the operations of this step refer to, or may be performed by, circuitry for obtaining and/or code for obtaining as described with reference to FIG. 16.

In some aspects, the method 1500 further includes applying the update to the PUCCH resource an action time after acknowledging the additional signaling. In some cases, the operations of this step refer to, or may be performed by, circuitry for applying and/or code for applying as described with reference to FIG. 16.

In some aspects, the UCI comprises a SR; the update to the PUCCH resource comprises an update to an SR resource; and the additional signaling indicates an update to the SR resource by activating or deactivating SR transmission according to an SR configuration.

In one aspect, method 1500, or any aspect related to it, may be performed by an apparatus, such as communications device 1600 of FIG. 16, which includes various components operable, configured, or adapted to perform the method 1500. Communications device 1600 is described below in further detail.

Note that FIG. 15 is just one example of a method, and other methods including fewer, additional, or alternative steps are possible consistent with this disclosure.

### Example Communications Device

FIG. 16 depicts aspects of an example communications device 1600. In some aspects, communications device 1600 is a user equipment, such as UE 104 described above with respect to FIGS. 1 and 3. In some aspects, communications device 1600 is a network entity, such as BS 102 of FIGS. 1 and 3, or a disaggregated base station as discussed with respect to FIG. 2.

The communications device 1600 includes a processing system 1605 coupled to the transceiver 1665 (e.g., a transmitter and/or a receiver). In some aspects (e.g., when communications device 1600 is a network entity), processing system 1605 may be coupled to a network interface 1675 that is configured to obtain and send signals for the communications device 1600 via communication link(s), such as a backhaul link, midhaul link, and/or fronthaul link as described herein, such as with respect to FIG. 2. The transceiver 1665 is configured to transmit and receive signals for the communications device 1600 via the antenna 1670, such as the various signals as described herein. The processing system 1605 may be configured to perform processing functions for the communications device 1600, including processing signals received and/or to be transmitted by the communications device 1600.

The processing system 1605 includes one or more processors 1610. In various aspects, the one or more processors 1610 may be representative of one or more of receive processor 358, transmit processor 364, TX MIMO processor 366, and/or controller/processor 380, as described with respect to FIG. 3. In various aspects, one or more processors 1610 may be representative of one or more of receive processor 338, transmit processor 320, TX MIMO processor 330, and/or controller/processor 340, as described with respect to FIG. 3. The one or more processors 1610 are coupled to a computer-readable medium/memory 1635 via a bus 1660. In certain aspects, the computer-readable medium/memory 1635 is configured to store instructions (e.g., computer-executable code) that when executed by the one or more processors 1610, cause the one or more processors 1610 to perform the method 1400 described with respect to FIG. 14, or any aspect related to it; and the method 1500 described with respect to FIG. 15, or any aspect related to it. Note that reference to a processor performing a function of communications device 1600 may include one or more processors 1610 performing that function of communications device 1600.

In the depicted example, computer-readable medium/memory 1635 stores code (e.g., executable instructions), such as code for obtaining 1640, code for outputting 1645, code for applying 1650, and code for terminating 1655. Processing of the code for obtaining 1640, code for outputting 1645, code for applying 1650, and code for terminating 1655 may cause the communications device 1600 to perform the method 1400 described with respect to FIG. 14, or any aspect related to it; and the method 1500 described with respect to FIG. 15, or any aspect related to it.

The one or more processors 1610 include circuitry configured to implement (e.g., execute) the code stored in the computer-readable medium/memory 1635, including circuitry for obtaining 1615, circuitry for outputting 1620, circuitry for applying 1625, and circuitry for terminating 1630. Processing with circuitry for obtaining 1615, circuitry for outputting 1620, circuitry for applying 1625, and circuitry for terminating 1630 may cause the communications device 1600 to perform the method 1400 described with respect to FIG. 14, or any aspect related to it; and the method 1500 described with respect to FIG. 15, or any aspect related to it.

Various components of the communications device 1600 may provide means for performing the method 1400 described with respect to FIG. 14, or any aspect related to it; and the method 1500 described with respect to FIG. 15, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1665 and the antenna 1670 of the communications device 1600 in FIG. 16. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1665 and the antenna 1670 of the communications device 1600 in FIG. 16. Means for outputting, means for transmitting, means for obtaining, means for receiving, means for applying, means for processing, means for performing, means for updating, and/or means for acknowledging may include one or more processors, transceivers, or other type of circuitry.

### Example Clauses

Implementation examples are described in the following numbered clauses:

Clause 1: A method for wireless communications at a network node (e.g., a UE), comprising: obtaining RRC signaling configuring the network node with at least one PUCCH resource; obtaining additional signaling indicating an update to the PUCCH resource; and outputting, for transmission, UCI using the updated PUCCH resource.

Clause 2: The method of Clause 1, wherein the UCI comprises a SR.

Clause 3: The method of Clause 2, wherein the SR is output for transmission to terminate a power saving mode.

Clause 4: The method of Clause 3, wherein the power saving mode involves at least one of PDCCH skipping or SSSG switching.

Clause 5: The method of any one of Clauses 1-4, wherein the additional signaling indicates the update to the PUCCH resource via an updated slot offset or a PUCCH resource ID.

Clause 6: The method of any one of Clauses 1-5, wherein the additional signaling indicates an update to at least one of: a time domain resource allocation of the PUCCH resource; a frequency domain resource allocation of the PUCCH resource; or a code domain resource allocation configuration of the PUCCH resource.

Clause 7: The method of any one of Clauses 1-6, wherein the additional signaling comprises at least one of: a PDCCH or a MAC-CE.

Clause 8: The method of Clause 7, wherein: the MAC-CE indicates a set of options for updating the PUCCH resource; and the PDCCH indicates one of the set of options.

Clause 9: The method of any one of Clauses 1-8, further comprising obtaining signaling configuring the network node with PUCCH occasions, wherein the additional signaling indicates the update to the PUCCH resource as an indication of valid occasions for PUCCH transmission among configured PUCCH occasions.

Clause 10: The method of any one of Clauses 1-9, wherein: the additional signaling indicates an update to the PUCCH resource to use in conjunction with a beam switch to a new beam; and the UCI is output, for transmission, using the new beam.

Clause 11: The method of any one of Clauses 1-10, wherein the additional signaling also indicates the beam switch.

Clause 12: The method of Clause 11, further comprising: obtaining signaling configuring the UE with multiple PUCCH resources associated with different beams, wherein the additional signaling indicates the update to the PUCCH resource and the beam switch by identifying one of the multiple PUCCH resources.

Clause 13: The method of Clause 11, further comprising: obtaining signaling configuring the network node with multiple TCI states, each associated with an offset in at least one of: a time domain, a frequency domain, or a code domain, wherein the additional signaling indicates the update to the PUCCH resource and the beam switch by identifying one of the TCI states; and applying the offset to update the PUCCH resource.

Clause 14: The method of any one of Clauses 1-13, wherein the UCI comprises at least one of a HARQ ACK feedback or CSI.

Clause 15: The method of Clause 14, wherein the additional signaling indicates at least one of: an update to a PUCCH resource ID associated with a SPS configuration for the HARQ ACK feedback; activation or deactivation of at least one PUCCH resource configured in an SPS PUCCH HARQ ACK feedback list; activation or deactivation of one or more PUCCH resource configured in a multiple CSI PUCCH resource list; or at least one PUCCH resource associated with a CSI report configuration.

Clause 16: The method of any one of Clauses 1-15, wherein the additional signaling conveys parameters including one or more of: a MAC-CE that includes at least one of: a serving cell ID, a BWP ID, a SR ID, a slot offset, a PUCCH resource ID, or a MAC-CE type indicating what parameters are included in the MAC-CE.

Clause 17: The method of any one of Clauses 1-16, comprising applying the update to the PUCCH resource an action time after acknowledging the additional signaling.

Clause 18: The method of any one of Clauses 1-17, wherein: the UCI comprises a SR; the update to the PUCCH resource comprises an update to an SR resource; and the additional signaling indicates an update to the SR resource by activating or deactivating SR transmission according to an SR configuration.

Clause 19: A method for wireless communications at a network node, comprising: outputting, for transmission, RRC signaling configuring a UE with at least one PUCCH resource; outputting, for transmission, additional signaling indicating an update to the PUCCH resource; and obtaining UCI using the updated PUCCH resource.

Clause 20: The method of Clause 19, wherein the UCI comprises a SR.

Clause 21: The method of Clause 20, further comprising terminating a power saving mode of the UE after obtaining the SR.

Clause 22: The method of Clause 21, wherein the power saving mode involves at least one of PDCCH skipping or SSSG switching.

Clause 23: The method of any one of Clauses 19-22, wherein the additional signaling indicates the update to the PUCCH resource via an updated slot offset or a PUCCH resource ID.

Clause 24: The method of any one of Clauses 19-23, wherein the additional signaling indicates an update to at least one of: a time domain resource allocation of the PUCCH resource; a frequency domain resource allocation of the PUCCH resource; or a code domain resource allocation configuration of the PUCCH resource.

Clause 25: The method of any one of Clauses 19-24, wherein the additional signaling comprises at least one of: a PDCCH or a MAC-CE.

Clause 26: The method of Clause 25, wherein: the MAC-CE indicates a set of options for updating the PUCCH resource; and the PDCCH indicates one of the set of options.

Clause 27: The method of any one of Clauses 19-26, further comprising outputting, for transmission, signaling configuring the UE with PUCCH occasions, wherein the additional signaling indicates the update to the PUCCH resource as an indication of valid occasions for PUCCH transmission among configured PUCCH occasions.

Clause 28: The method of any one of Clauses 19-27, wherein the additional signaling indicates an update to the PUCCH resource to use in conjunction with a beam switch to a new beam.

Clause 29: The method of any one of Clauses 19-28, wherein the additional signaling also indicates the beam switch.

Clause 30: The method of Clause 29, further comprising: outputting, for transmission, signaling configuring the UE with multiple PUCCH resources associated with different beams, wherein the additional signaling indicates the update to the PUCCH resource and the beam switch by identifying one of the multiple PUCCH resources.

Clause 31: The method of Clause 29, further comprising: outputting, for transmission, signaling configuring the UE with multiple TCI states, each associated with an offset in at least one of: a time domain, a frequency domain, or a code domain, wherein the additional signaling indicates the update to the PUCCH resource and the beam switch by identifying one of the TCI states; and applying the offset to update the PUCCH resource.

Clause 32: The method of any one of Clauses 19-31, wherein the UCI comprises at least one of a HARQ ACK feedback or CSI.

Clause 33: The method of Clause 32, wherein the additional signaling indicates at least one of: an update to a PUCCH resource ID associated with a SPS configuration for the HARQ ACK feedback; activation or deactivation of at least one PUCCH resource configured in an SPS PUCCH HARQ ACK feedback list; activation or deactivation of one or more PUCCH resource configured in a multiple CSI PUCCH resource list; or at least one PUCCH resource associated with a CSI report configuration.

Clause 34: The method of any one of Clauses 19-33, wherein the additional signaling conveys parameters including one or more of: a MAC-CE that includes at least one of: a serving cell ID, a BWP ID, a SR ID, a slot offset, a PUCCH resource ID, or a MAC-CE type indicating what parameters are included in the MAC-CE.

Clause 35: The method of any one of Clauses 19-34, further comprising: obtaining acknowledgement of the additional signaling from the UE; and applying the update to the PUCCH resource an action time after acknowledging the additional signaling.

Clause 36: The method of any one of Clauses 19-35, wherein: the UCI comprises a SR; the update to the PUCCH resource comprises an update to an SR resource; and the additional signaling indicates an update to the SR resource by activating or deactivating SR transmission according to an SR configuration.

Clause 37: An apparatus, comprising: a memory comprising executable instructions; and a processor configured to execute the executable instructions and cause the apparatus to perform a method in accordance with any one of Clauses 1-36.

Clause 38: An apparatus, comprising means for performing a method in accordance with any one of Clauses 1-36.

Clause 39: A non-transitory computer-readable medium comprising executable instructions that, when executed by a processor of an apparatus, cause the apparatus to perform a method in accordance with any one of Clauses 1-36.

Clause 40: A computer program product embodied on a computer-readable storage medium comprising code for performing a method in accordance with any one of Clauses 1-36.

Clause 41: A network node (e.g., a UE), comprising: at least one transceiver; a memory comprising instructions; and one or more processors configured to execute the instructions and cause the network node to perform a method in accordance with any one of Clauses 1-18, wherein the at least one transceiver is configured to receive the RRC signaling, receive the additional signaling, and transmit the UCI.

Clause 42: A network node, comprising: at least one transceiver; a memory comprising instructions; and one or more processors configured to execute the instructions and cause the network node to perform a method in accordance with any one of Clauses 19-36, wherein the at least one transceiver is configured to transmit the RRC signaling, transmit the additional signaling, and receive the UCI.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, the term wireless node may refer to, for example, a network entity or a user equipment (UE). In this context, a network entity may be a base station (e.g., a gNB) or a module (e.g., a CU, DU, and/or RU) of a disaggregated base station.

While the present disclosure may describe certain operations as being performed by one type of wireless node, the same or similar operations may also be performed by another type of wireless node. For example, operations performed by a network entity may also (or instead) be performed by a UE. Similarly, operations performed by a UE may also (or instead) be performed by a network entity.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse direction relative to what is described (e.g., a UE could transmit a request to a network entity and the network entity transmits a response; OR a network entity could transmit the request to a UE and the UE transmits the response).

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication, comprising: a memory comprising instructions; and one or more processors configured to execute the instructions and cause the apparatus to:
obtain radio resource control (RRC) signaling configuring the apparatus with at least one physical uplink control channel (PUCCH) resource;
obtain additional signaling indicating an update to the PUCCH resource; and
output, for transmission, uplink control information (UCI) using the updated PUCCH resource.

2. The apparatus of claim 1, wherein:
the UCI comprises a scheduling request (SR);
the SR is indicative of termination of a power saving mode; and
the power saving mode involves at least one of physical downlink control channel (PDCCH) skipping or search space set group (SSSG) switching.

3. The apparatus of claim 1, wherein:
the additional signaling indicates the update to the PUCCH resource via an updated slot offset or a PUCCH resource identifier (ID); and
the additional signaling indicates an update to at least one of:
a time domain resource allocation of the PUCCH resource;
a frequency domain resource allocation of the PUCCH resource; or
a code domain resource allocation configuration of the PUCCH resource.

4. The apparatus of claim 1, wherein:
the additional signaling comprises at least one of: a physical downlink control channel (PDCCH) or a medium access control (MAC) control element (CE);
the MAC CE indicates a set of options for updating the PUCCH resource; and
the PDCCH indicates one of the set of options.

5. The apparatus of claim 1, wherein the one or more processors are further configured to execute the instructions and cause the apparatus to obtain signaling configuring the apparatus with PUCCH occasions, wherein the additional signaling indicates the update to the PUCCH resource as an indication of valid occasions for PUCCH transmission among configured PUCCH occasions.

6. The apparatus of claim 1, wherein:
the additional signaling indicates the update to the PUCCH resource is also to be used in conjunction with a beam switch to a new beam; and
the UCI is output, for transmission, using the new beam.

7. The apparatus of claim 6, wherein the additional signaling also indicates the beam switch.

8. The apparatus of claim 7, wherein the one or more processors are further configured to execute the instructions and cause the apparatus to:
obtain signaling configuring the apparatus with multiple other PUCCH resources associated with different beams, wherein the additional signaling indicates the update to the PUCCH resource and the beam switch by identifying one of the multiple other PUCCH resources.

9. The apparatus of claim 7, wherein the one or more processors are further configured to execute the instructions and cause the apparatus to:
obtain signaling configuring the apparatus with multiple transmission configuration indicator (TCI) states, each associated with an offset in at least one of: a time domain, a frequency domain, or a code domain, wherein the additional signaling indicates the update to the PUCCH resource and the beam switch by identifying one of the TCI states; and
apply the offset to update the PUCCH resource.

10. The apparatus of claim 1, wherein:
the UCI comprises at least one of a hybrid automatic repeat request (HARQ) acknowledgment (ACK) feedback or channel state information (CSI); and
the additional signaling further indicates at least one of:
an update to a physical uplink control channel (PUCCH) resource (ID) associated with a semi-persistent scheduling (SPS) configuration for the HARQ ACK feedback;
activation or deactivation of at least one other PUCCH resource configured in an SPS PUCCH HARQ ACK feedback list;
activation or deactivation of one or more other PUCCH resources configured in a multiple CSI PUCCH resource list; or
at least one other PUCCH resource associated with a CSI report configuration.

11. The apparatus of claim 1, wherein the additional signaling conveys parameters including at least one of: a medium access control (MAC) control element (CE) that includes at least one of: a serving cell ID, a bandwidth part (BWP) ID, a scheduling request (SR) ID, a slot offset, a PUCCH resource ID, or a MAC CE type indicating what parameters are included in the MAC CE.

12. The apparatus of claim 1, wherein the one or more processors are further configured to execute the instructions and cause the apparatus to:
acknowledge the additional signaling; and
apply the update to the PUCCH resource, resulting in the updated PUCCH resource, an action time after acknowledging the additional signaling.

13. The apparatus of claim 1, wherein:
the UCI comprises a scheduling request (SR); and
the additional signaling indicates an update to the PUCCH resource according to an SR configuration.

14. The apparatus of claim 1, further comprising at least one transceiver configured to receive the RRC signaling, receive the additional signaling, and transmit the UCI, wherein the apparatus is configured as a user equipment (UE).

15. An apparatus for wireless communication, comprising: a memory comprising instructions; and one or more processors configured to execute the instructions and cause the apparatus to:
output, for transmission, radio resource control (RRC) signaling configuring a user equipment (UE) with at least one physical uplink control channel (PUCCH) resource;
output, for transmission, additional signaling indicating an update to the PUCCH resource; and
obtain uplink control information (UCI) using the updated PUCCH resource.

16. The apparatus of claim 15, wherein:
the UCI comprises a scheduling request (SR);
the one or more processors are further configured to execute the instructions and cause the apparatus to terminate a power saving mode of the UE after obtaining the SR; and
the power saving mode involves at least one of physical downlink control channel (PDCCH) skipping or search space set group (SSSG) switching.

17. The apparatus of claim 15, wherein:
the additional signaling indicates the update to the PUCCH resource via an updated slot offset or a PUCCH resource identifier (ID); and
the additional signaling indicates an update to at least one of:
a time domain resource allocation of the PUCCH resource;
a frequency domain resource allocation of the PUCCH resource; or
a code domain resource allocation configuration of the PUCCH resource.

18. The apparatus of claim 15, wherein:
the additional signaling comprises at least one of: a physical downlink control channel (PDCCH) or a medium access control (MAC) control element (CE);
the MAC CE indicates a set of options for updating the PUCCH resource; and
the PDCCH indicates one of the set of options.

19. The apparatus of claim 15, wherein the one or more processors are further configured to execute the instructions and cause the apparatus to output, for transmission, signaling configuring the UE with PUCCH occasions, wherein the additional signaling indicates the update to the PUCCH resource as an indication of valid occasions for PUCCH transmission among the configured PUCCH occasions.

20. The apparatus of claim 15, wherein the additional signaling indicates the update to the PUCCH resource is also to be used in conjunction with a beam switch to a new beam.

21. The apparatus of claim 20, wherein the additional signaling also indicates the beam switch.

22. The apparatus of claim 21, wherein the one or more processors are further configured to execute the instructions and cause the apparatus to:
output, for transmission, signaling configuring the UE with multiple PUCCH resources associated with different beams, wherein the additional signaling indicates the update to the PUCCH resource and the beam switch by identifying one of the multiple PUCCH resources.

23. The apparatus of claim 21, wherein the one or more processors are further configured to execute the instructions and cause the apparatus to:
output, for transmission, signaling configuring the UE with multiple transmission configuration indicator (TCI) states, each associated with an offset in at least one of: a time domain, a frequency domain, or a code domain, wherein the additional signaling indicates the update to the PUCCH resource and the beam switch by identifying one of the TCI states; and
apply the offset to update the PUCCH resource.

24. The apparatus of claim 15, wherein:
the UCI comprises at least one of a hybrid automatic repeat request (HARQ) acknowledgment (ACK) feedback or channel state information (CSI); and
the additional signaling indicates at least one of:
an update to a physical uplink control channel (PUCCH) resource (ID) associated with a semi-persistent scheduling (SPS) configuration for the HARQ ACK feedback;
activation or deactivation of at least one PUCCH resource configured in an SPS PUCCH HARQ ACK feedback list;
activation or deactivation of one or more PUCCH resource configured in a multiple CSI PUCCH resource list; or
at least one PUCCH resource associated with a CSI report configuration.

25. The apparatus of claim 15, wherein the additional signaling conveys parameters including one or more of: a medium access control (MAC) control element (CE) that includes at least one of: a serving cell ID, a bandwidth part (BWP) ID, a scheduling request (SR) ID, a slot offset, a PUCCH resource ID, or a MAC CE type indicating what parameters are included in the MAC CE.

26. The apparatus of claim 15, wherein the one or more processors are further configured to execute the instructions and cause the apparatus to:
obtain acknowledgement of the additional signaling from the UE; and
applying the update to the PUCCH resource an action time after acknowledging the additional signaling.

27. The apparatus of claim 15, wherein:
the UCI comprises a scheduling request (SR);
the update to the PUCCH resource comprises an update to an SR resource; and
the additional signaling indicates an update to the SR resource by activating or deactivating SR transmission according to an SR configuration.

28. The apparatus of claim 15, further comprising at least one transceiver configured to transmit the RRC signaling, transmit the additional signaling, and receive the UCI, wherein the apparatus is configured as a network entity.

29. A method for wireless communication at a network node, comprising:
obtaining radio resource control (RRC) signaling configuring the network node with at least one physical uplink control channel (PUCCH) resource;
obtaining additional signaling indicating an update to the PUCCH resource; and
outputting uplink control information (UCI) using the updated PUCCH resource.
